(19) United States
(12) Patent Application Publication
(10) Pub. No.: US 2022/0261978 A1
(43) Pub. Date: Aug. 18, 2022

(54) VEHICLE EXTERIOR IMAGING SYSTEM

(71) Applicant: TOYOTA JIDOSHA KABUSHIKI KAISHA, Aichi-ken (JP)

(72) Inventors: Takeshi MURAKAMI, Okazaki-shi (JP); Kenji YAMAGUCHI, Toyota-shi (JP)

(21) Appl. No.: 17/667,542

(22) Filed: Feb. 9, 2022

(30) Foreign Application Priority Data
Feb. 12, 2021 (JP) 2021-021319

(51) Int. Cl. G06T 7/00; B60S 3/04; H04N 5/247; H04N 5/225; H04N 5/232

(52) U.S. Cl. CPC G06T 7/0002; B60S 3/04; H04N 5/23299; H04N 5/2256; H04N 5/247

(57) ABSTRACT

In a vehicle exterior imaging system, when a vehicle is washed with a vehicle washer, an image of an exterior of the vehicle is captured by a camera provided in an assessment device, and the captured image data is acquired by a capture image data acquisition unit. Flaws are detected by a flaw detection unit from the captured image data, and presentation image data including detected flaw information is sent by a sending unit to a user terminal. Thus, a user or a manager is able to check for flaws on a vehicle, and locations, degrees, and the like of flaws from a presentation image each time of a vehicle wash of the vehicle.

### CROSS-REFERENCE TO RELATED APPLICATION

This application claims priority to Japanese Patent Application No. 2021-021319 filed on Feb. 12, 2021, incorporated herein by reference in its entirety.

### BACKGROUND

### 1. Technical Field

The disclosure relates to a vehicle exterior imaging system.

### 2. Description of Related Art

Users and managers of vehicles desire to check for flaws and soil on the exteriors of the vehicles as early as possible. However, it is complicated to ask dealers and the like to check for flaws, so it is desired to more easily check for flaws.

For example, it is conceivable to provide a vehicle washer with a camera or the like and detect flaws on the exterior of a vehicle during a vehicle wash.

Incidentally, Japanese Unexamined Patent Application Publication No. 2017-214024 (JP 2017-214024 A) suggests a vehicle washing machine. The vehicle washing machine provides a vehicle washer with an imaging apparatus, captures the images of a state of a vehicle before a vehicle wash, and prevents a vehicle wash in a state inappropriate for a vehicle wash, and also enables easy identification of an accident cause during a vehicle wash by saving the captured images.

### SUMMARY

The vehicle washing machine described in JP 2017-214024 A intends to prevent an accident during a vehicle wash, for example, an accident during a vehicle wash due to forgetting to close a lid for a fuel inlet or other causes or to identify an accident cause, so the images of specified areas of the sides and top of a vehicle are captured before a vehicle wash.

Therefore, the vehicle washing machine does not obtain captured images over the entire exterior of a vehicle. Since the images of a vehicle are captured before a vehicle wash, the vehicle is presumably soiled, and it is not desirable from the viewpoint of flaw detection.

In other words, there is room for improvement in terms of simply performing flaw detection.

The disclosure provides a vehicle exterior imaging system that enables a user of a vehicle or a manager of a vehicle to easily check for flaws on an exterior of the vehicle.

An aspect of the disclosure relates to a vehicle exterior imaging system. The vehicle exterior imaging system includes an exterior image data acquisition unit configured to acquire exterior image data of a washed vehicle of which an image is captured by an imaging apparatus integrally provided with a vehicle washer that washes the vehicle while moving relative to the vehicle, a flaw detection unit configured to detect flaws on an exterior of the vehicle based on the exterior image data, and a presentation image data generation unit configured to generate presentation image data in which flaw information detected by the flaw detection unit is added to the exterior image data.

In the vehicle exterior imaging system, when a vehicle is washed by the vehicle washer, the exterior image data acquisition unit acquires exterior image data of the washed vehicle of which an image is captured by the imaging apparatus integrally provided with the vehicle washer. The flaw detection unit detects flaws on the exterior of the vehicle based on the exterior image data. The presentation image data generation unit generates presentation image data by adding flaw information detected by the flaw detection unit to the exterior image data.

By consulting the presentation image data, a user or a manager is able to check for flaws on the exterior of the vehicle and the locations, degrees, and the like of the flaws each time of a vehicle wash.

The phrase “the imaging apparatus integrally provided with the vehicle washer” means that the imaging apparatus is provided continuously with the vehicle washer. When the vehicle washer moves relative to a vehicle, it means that the imaging apparatus moves together with the vehicle washer. When a vehicle moves relative to the vehicle washer, it means that the imaging apparatus is placed downstream of the vehicle washer.

The vehicle exterior imaging system of the above aspect may further include a sending unit configured to send the presentation image data to a terminal of a user of the vehicle or a terminal of a manager of the vehicle.

In this vehicle exterior imaging system, the sending unit sends presentation image data to a terminal of a user (hereinafter, referred to as user terminal) or a terminal of a manager (hereinafter, referred to as manager terminal) of the vehicle. Therefore, the user or the manager of the vehicle is able to check for flaws on the exterior of the vehicle and the locations, degrees, and the like of the flaws only by viewing the presentation image data on the user terminal or the manager terminal after a vehicle wash of the vehicle.

In the vehicle exterior imaging system of the above aspect, the exterior image data acquisition unit may be configured to acquire exterior image data of the vehicle with the imaging apparatus even before a vehicle wash of the vehicle.

In this vehicle exterior imaging system, the exterior image data acquisition unit acquires exterior image data of the vehicle before and after a vehicle wash, captured by the imaging apparatus. The user or the manager is able to check removal of soil through a vehicle wash by, for example, comparing both exterior images with each other. Alternatively, by generating a differential image between an exterior image before a vehicle wash and an exterior image after a vehicle wash with the vehicle exterior imaging system, the user or the manager is able to easily check for soil removed through a vehicle wash by viewing a differential image.

In the vehicle exterior imaging system of the above aspect, the imaging apparatus may include a housing covering an area through which the vehicle relatively passes, and the imaging apparatus may include a camera placed on an inner side of the housing and configured to capture an image of the exterior of the vehicle.

In this vehicle exterior imaging system, the housing covers an area through which the vehicle passes relative to the imaging apparatus. The camera that captures an image of the exterior of the vehicle is placed on the inner side of the housing. Therefore, when the image of the vehicle that passes relative to the imaging apparatus is captured, exposure of the exterior part of the vehicle to ambient light is prevented or reduced with the housing. Incidence of light that is ambient light reflected from the exterior into the camera placed on the inner side of the housing is prevented or reduced, and flaw detection accuracy based on exterior image data in the flaw detection unit improves.

In the vehicle exterior imaging system of the above aspect, the imaging apparatus may include a plurality of cameras configured to respectively capture images of different areas of the exterior of the vehicle in a cross section perpendicular to a direction in which the vehicle moves relative to the imaging apparatus.

In this vehicle exterior imaging system, the imaging apparatus includes the plurality of cameras that capture the images of different areas of the exterior of the vehicle in the cross section perpendicular to the direction in which the vehicle moves relative to the imaging apparatus. Therefore, an exterior image can be captured uniformly over the entire circumference of the exterior of the vehicle with the plurality of cameras. In other words, the image of the entire exterior of the vehicle can be captured thoroughly.

The phrase “the different areas of the exterior of the vehicle” means that at least part of the exterior of the vehicle just needs to be different (an overlap part may be included).

In the vehicle exterior imaging system of the above aspect, the imaging apparatus may include a plurality of lighting devices respectively associated with the plurality of cameras, and each of the plurality of cameras may be configured to sequentially capture an image of the exterior of the vehicle in a state where only the lighting device associated with an associated one of the cameras is turned on.

In this vehicle exterior imaging system, the imaging apparatus sequentially captures the image of the vehicle exterior with the plurality of cameras. At this time, at the time of capturing an image with each camera, only the lighting device associated with that camera is turned on. Therefore, each camera captures the image of the vehicle exterior in a state where only an associated one of the lighting devices is turned on, in other words, incidence of unnecessary light into the camera is prevented or reduced, so each camera is able to capture an exterior image with which flaw detection is easy.

In the vehicle exterior imaging system of the above aspect, the imaging apparatus may include an exterior shape information acquisition unit configured to acquire exterior shape information of a vehicle, and a camera displacement control unit configured to displace the camera to a location according to the exterior shape of the vehicle based on the exterior shape information.

In this vehicle exterior imaging system, the camera is moved by the camera displacement unit to the location according to the exterior shape of the vehicle based on the exterior shape information of the vehicle, acquired by the exterior shape information acquisition unit. In other words, the location of the camera is changeable according to the exterior shape of the vehicle, so the exterior image of the overall vehicle can be captured regardless of the exterior shape of the vehicle.

In the vehicle exterior imaging system of the above aspect, the presentation image data generation unit may be configured to generate presentation image data in which capture date and time information and capture place information are added to exterior image data of the washed vehicle.

In this vehicle exterior imaging system, presentation image data in which capture date and time information, capture place information, and the like are further added to exterior image data captured during a vehicle wash is generated. In other words, the fact that presentation image data is information captured by the vehicle exterior imaging system is guaranteed. Thus, the user or the manager is able to use presentation image data as objective data for used car assessment or the like on the Internet.

As described above, with the vehicle exterior imaging system according to the aspect of the disclosure, the user or the manager is able to easily check for flaws on the exterior of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing the appearance of a vehicle exterior imaging system according to an embodiment;

FIG. 2 is a side view of the vehicle exterior imaging system according to the embodiment;

FIG. 3 is a cross-sectional view taken along the line B-B in FIG. 2;

FIG. 4 is a block diagram showing the hardware configuration of the vehicle exterior imaging system according to the embodiment;

FIG. 5 is a block diagram showing the hardware configuration of an assessment ECU according to the embodiment;

FIG. 6 is a block diagram showing the functional components of the assessment ECU according to the embodiment; and

FIG. 7 is a view showing the relation between the vehicle exterior imaging system according to the embodiment and a user terminal.

### DETAILED DESCRIPTION OF EMBODIMENTS

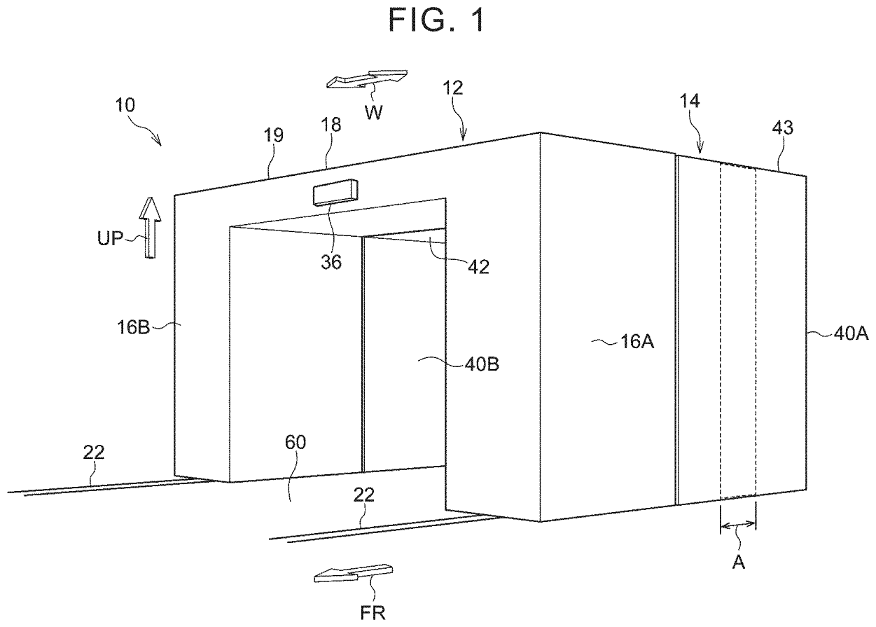

Hereinafter, a vehicle exterior imaging system according to an embodiment will be described with reference to FIG. 1 to FIG. 7. A direction in which rails 22 (described later) extend is referred to as “front and rear direction”. In FIG. 1 to FIG. 3, the arrow FR indicates a front side, the arrow UP indicates an upper side, and the double-headed arrow W indicates a width direction.

Initially, the mechanical configuration of a vehicle exterior imaging system 10 will be described. As shown in FIG. 1, the vehicle exterior imaging system 10 combines a vehicle washer 12 with an assessment device 14 as one unit. The assessment device 14 may be regarded as an imaging apparatus.

As shown in FIG. 1, the vehicle washer 12 includes a vehicle washer body 19. The vehicle washer body 19 is made up of a pair of leg portions 16A, 16B extending in an up and down direction, and a top portion 18 connecting the upper ends of the leg portions 16A, 16B. The vehicle washer body 19 is formed in a substantially inverted U-shape as a whole.

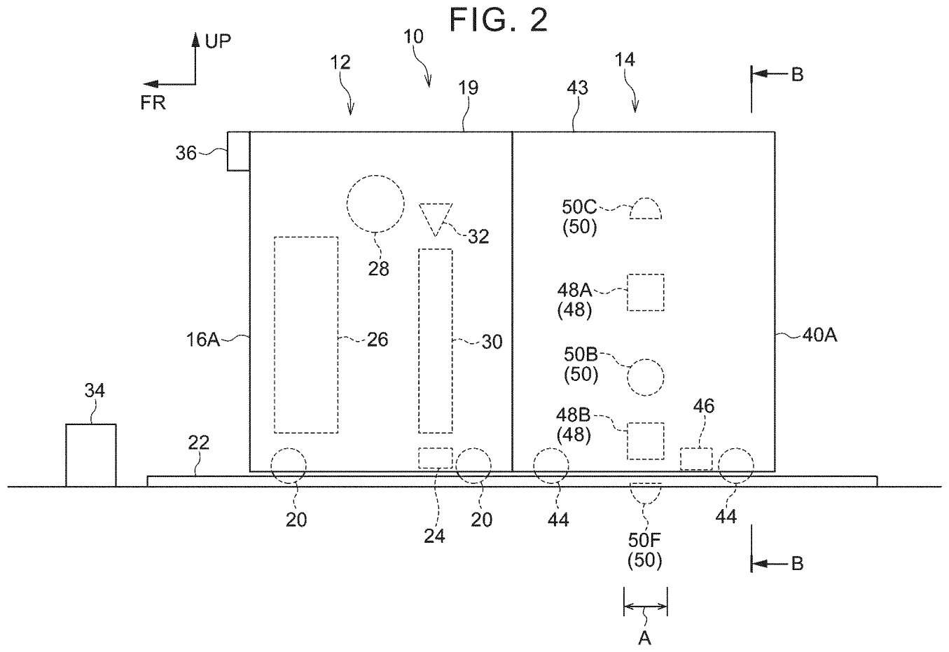

As shown in FIG. 2, the vehicle washer body 19 is configured such that a pair of wheels 20 is provided at the lower end of each of the leg portions 16A, 16B, the pair of wheels 20 is driven for rotation by driving a vehicle washer body drive motor 24 provided in an associated one of the leg portions 16A, 16B, and the vehicle washer body 19 is movable on the rails 22 in the front and rear direction.

As shown in FIG. 2, side brushes 26 for washing a vehicle are respectively provided on the leg portions 16A, 16B of the vehicle washer body 19 on the sides adjacent to the other leg portions 16B, 16A (hereinafter, referred to as “on the inner side of the vehicle washer body 19”), and a top brush 28 for washing a vehicle is provided on the lower side of the top portion 18 (hereinafter, also referred to as “on the inner side of the vehicle washer body 19”). Side blower nozzles 30 and an upper blower nozzle 32 are provided on the inner side of the vehicle washer body 19 (not shown in FIG. 1). The side blower nozzles 30 are used to blow air on the sides of a vehicle. The upper blower nozzle 32 is used to blow air on the top of a vehicle.

As shown in FIG. 2, in the vehicle washer 12, a vehicle wash information input device 34 is provided in front of (in the arrow FR direction to) the vehicle washer body 19. The vehicle wash information input device 34 is a device that a user inputs a selected vehicle wash course, vehicle exterior shape information, such as a vehicle type, and a destination to which presentation image data (described later) is sent (such as the address of a user terminal).

A position detection unit 36 (see FIG. 2) or the like is provided on the vehicle front side of the top portion 18 of the vehicle washer body 19. The position detection unit 36 is made up of a camera, a sensor, or the like that detects whether a vehicle is stopped at a vehicle wash start position with respect to the vehicle washer body 19.

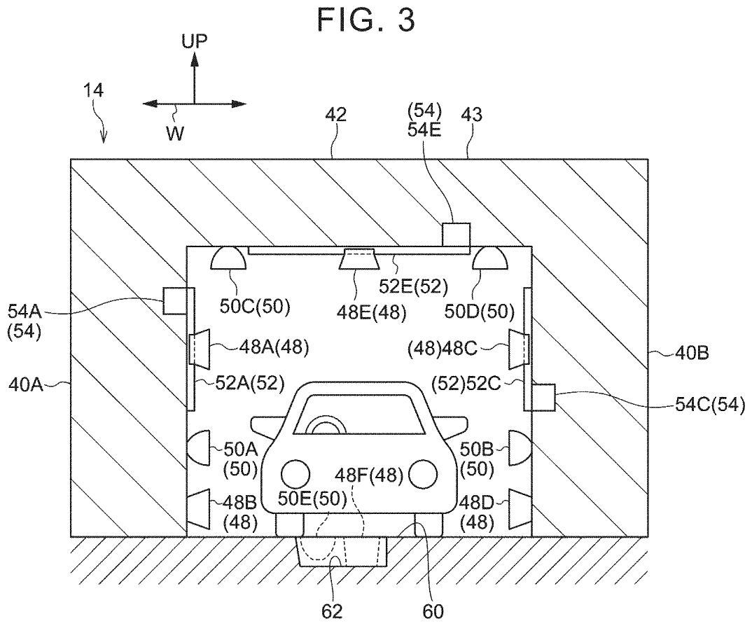

On the other hand, as shown in FIG. 1 and FIG. 3, the assessment device 14, as well as the vehicle washer 12, is made up of a pair of leg portions 40A, 40B and a top portion 42 connecting the upper ends of the leg portions 40A, 40B. The assessment device 14 includes an assessment device body 43 formed in a substantially inverted U-shape as a whole. The assessment device body 43 may be regarded as a housing.

As shown in FIG. 2, the assessment device 14 is also configured such that a pair of wheels 44 is provided at the lower end of each of the leg portions 40A, 40B, the pair of wheels 44 is driven for rotation by driving an assessment device body drive motor 46 provided in an associated one of the leg portions 40A, 40B, and the assessment device body 43 is movable on the rails 22 in the front and rear direction.

As shown in FIG. 1 and FIG. 2, the assessment device body 43 is provided with a plurality of cameras 48 (when distinguished from one another, referred to as cameras 48A, 48B, 48C, 48D, 48E, 48F (see FIG. 3)) and a plurality of lighting devices 50 (when distinguished from one another, referred to as lighting devices 50A, 50B, 50C, 50D, 50E (see FIG. 3)). The cameras 48 and the lighting devices 50 are provided in the same region A in the front and rear direction on the leg portions 40A, 40B on the sides adjacent to the other leg portions 40B, 40A and on the lower side of the top portion 42 (hereinafter, referred to as “on the inner side of the assessment device body 43”).

As shown in FIG. 3, the camera 48A and the camera 48B are disposed on the inner side of the leg portion 40A above and below, respectively. The upper-side camera 48A is used to capture the image of the right side upper part of a vehicle and is supported on a rail 52A extending in the up and down direction on the inner side of the leg portion 40A. The camera 48A is movable in the up and down direction along the rail 52A by driving a camera motor 54A.

On the other hand, the lower-side camera 48B is used to capture the image of the right side lower part of a vehicle and is fixed to the inner lower side of the leg portion 40A.

Similarly, the camera 48C and the camera 48D are disposed on the inner side of the leg portion 40B above and below, respectively. The upper-side camera 48C is used to capture the image of the left side upper part of a vehicle and is supported on a rail 52C extending in the up and down direction on the inner side of the leg portion 40B. The camera 48C is movable in the up and down direction along the rail 52C by driving a camera motor MC.

The lower-side camera 48D is used to capture the image of the left side lower part of a vehicle and is fixed to the inner lower side of the leg portion 40B.

The camera 48E used to capture the image of the top surface of a vehicle is disposed on the inner side of the top portion 42. The camera 48E is supported on a rail 52E extending in a width direction and is movable in the width direction (arrow W direction) along the rail 52E by driving a camera motor ME.

The camera 48F used to capture the image of the bottom surface of a vehicle is fixed in a recess 62 at the center of a floor surface 60 in the width direction.

In this way, since the five cameras 48A, 48B, 48C, 48D, 48E are disposed in the region A of the assessment device body 43 and the camera 48F is disposed on the floor surface 60, it is possible to capture the images of all the different regions on the exterior of the vehicle V in a cross section perpendicular to the front and rear direction of the vehicle V. Therefore, it is possible to capture the image of the entire exterior of the vehicle V with the cameras 48A, 48B, 48C, 48D, 48E, 48F by moving the assessment device body 43 in the front and rear direction or by moving the vehicle V in the front and rear direction.

The five lighting devices 50 are disposed on the inner side of the assessment device body 43.

The lighting device 50A is disposed between the camera 48A and the camera 48B on the inner side of the leg portion 40A. The lighting device 50B is disposed between the camera 48C and the camera 48D on the inner side of the leg portion 40B.

The lighting devices 50C, 50D are disposed outside the rail 52E (camera 48E) in the width direction on the inner side of the top portion 42.

The lighting device 50E is disposed in the recess 62 of the floor surface 60.

Next, the control configuration of controlling the vehicle exterior imaging system 10 will be described.

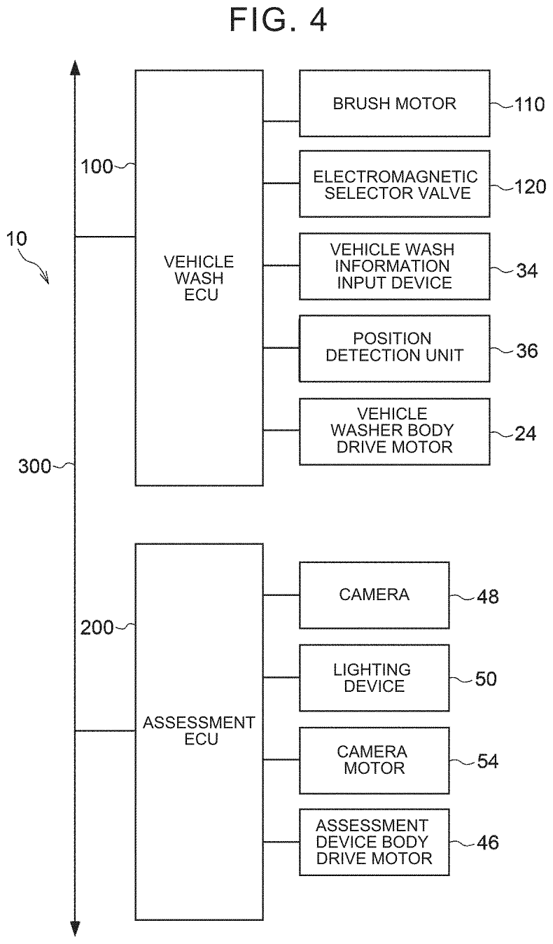

As shown in FIG. 4, in the vehicle exterior imaging system 10, a vehicle wash ECU 100 and an assessment ECU 200 are connected via a bus 300.

The vehicle wash ECU 100 is connected to a brush motor 110 that drives the side brushes 26 and top brush 28 of the vehicle washer 12. In other words, the vehicle wash ECU 100 is configured to rotate the side brushes 26 and the top brush 28 by outputting a drive signal to the brush motor 110.

The vehicle wash ECU 100 is connected to an electromagnetic selector valve 120 that controls the supply and cutoff of compressed air from a compressed air supply source (not shown) to the side blower nozzles 30 and the upper blower nozzle 32. In other words, the vehicle wash ECU 100 is configured to blow or stop blowing air from the side blower nozzles 30 and the upper blower nozzle 32 by outputting a control signal to the electromagnetic selector valve 120.

The vehicle wash ECU 100 is connected to the vehicle wash information input device 34. The vehicle wash ECU 100 is configured to start vehicle wash control (described later) in response to a signal indicating completion of input to the vehicle wash information input device 34. The vehicle wash course, vehicle exterior shape information, such as a vehicle type, a destination to which presentation image data is sent, and the like, input to the vehicle wash information input device 34, are configured to be output to the vehicle wash ECU 100.

The vehicle wash ECU 100 is connected to the position detection unit 36. The position detection unit 36 is configured to detect whether the vehicle V is stopped at a vehicle wash start position with respect to the vehicle washer body 19 based on a vehicle wash control signal input from the vehicle wash ECU 100 and output the determined result to the vehicle wash ECU 100.

The vehicle wash ECU 100 is connected to the vehicle washer body drive motor 24. The vehicle wash ECU 100 is configured to move the vehicle washer body 19 in the front and rear direction along the rails 22 by outputting a drive signal to the vehicle washer body drive motor 24.

On the other hand, the assessment ECU 200 is connected to the assessment device body drive motor 46. The assessment ECU 200 is configured to move the assessment device body 43 in the front and rear direction along the rails 22 by outputting a drive signal to the assessment device body drive motor 46. The assessment device body drive motor 46 is driven in synchronization with the vehicle washer body drive motor 24. In other words, the vehicle washer body 19 and the assessment device body 43 are configured to move integrally in the front and rear direction.

The assessment ECU 200 is connected to the cameras 48. The assessment ECU 200 outputs an image capture start signal to each of the cameras 48 and acquires captured image data from each of the cameras 48.

The assessment ECU 200 is connected to the lighting devices 50. The assessment ECU 200 outputs a turn-on signal to only the lighting device 50 appropriate for image capturing of each camera 48 in association with the image capture timing of each camera 48 and then outputs a turn-off signal to that lighting device 50 at the end of image capturing.

The assessment ECU 200 is connected to the camera motors 54 and outputs drive signals respectively to the camera motors 54 such that the cameras 48 are respectively moved to appropriate locations on the rails 52 in accordance with the vehicle exterior shape information.

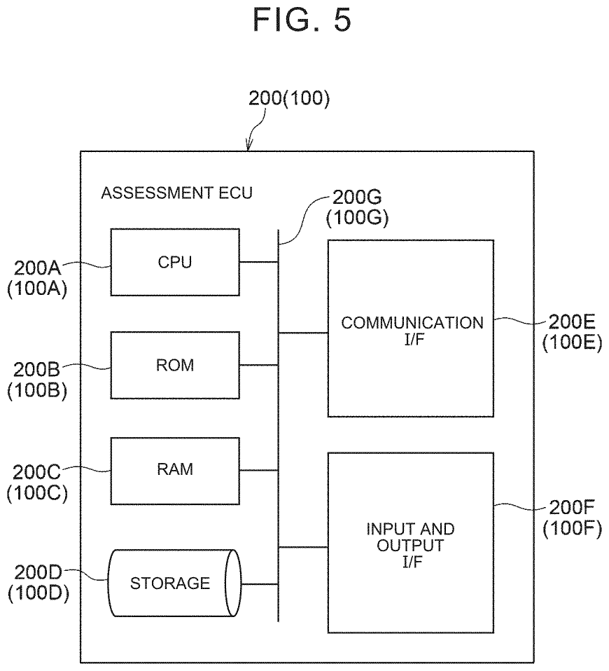

As shown in FIG. 5, the assessment ECU 200 includes a central processing unit (CPU) 200A, a read only memory (ROM) 200B, a random access memory (RAM) 200C, a storage 200D, a communication I/F 200E, and an input and output I/F 200F. The CPU 200A, the ROM 200B, the RAM 200C, the storage 200D, the communication I/F 200E, and the input and output I/F 200F are connected to one another via a bus 200G so as to be able to communicate with one another.

The CPU 200A is a central processing unit. The CPU 200A runs various programs and controls various units. In other words, the CPU 200A reads out programs from the ROM 200B and runs the programs by using the RAM 200C as a work area. In the present embodiment, execution programs are stored in the ROM 200B.

The ROM 200B stores various programs and various data. The RAM 200C temporarily stores programs or data as a work area.

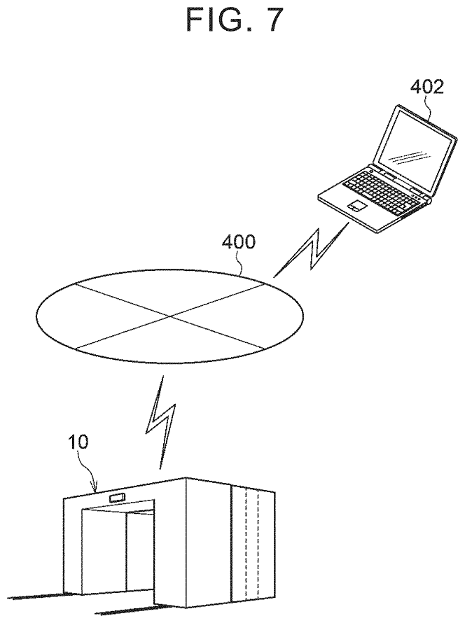

The communication I/F 200E is an interface for the vehicle exterior imaging system 10 to communicate with a user terminal 402 via a network 400 (see FIG. 7). In other words, the assessment ECU 200 is connected from the communication I/F 200E to the user terminal 402 via the network 400.

The user terminal 402 may be a terminal of a user of the vehicle V or may be a terminal of a manager of the vehicle V. The manager includes a management company that manages the vehicle V. The management company is, for example, a car-sharing company or the like.

The input and output I/F 200F is an interface for communicating with the vehicle wash ECU 100 via the bus 300. The assessment ECU 200 is connected from the input and output I/F 200F to the vehicle wash ECU 100 via the bus 300.

The vehicle wash ECU 100 has a substantially similar configuration to that of the assessment ECU 200, so the detailed description is omitted. When the CPU and the like of the vehicle wash ECU 100 are described, the same reference signs “A”, “B”, “C”, “D”, “E”, “F” are attached to the reference numerals “100” and the like (see FIG. 5).

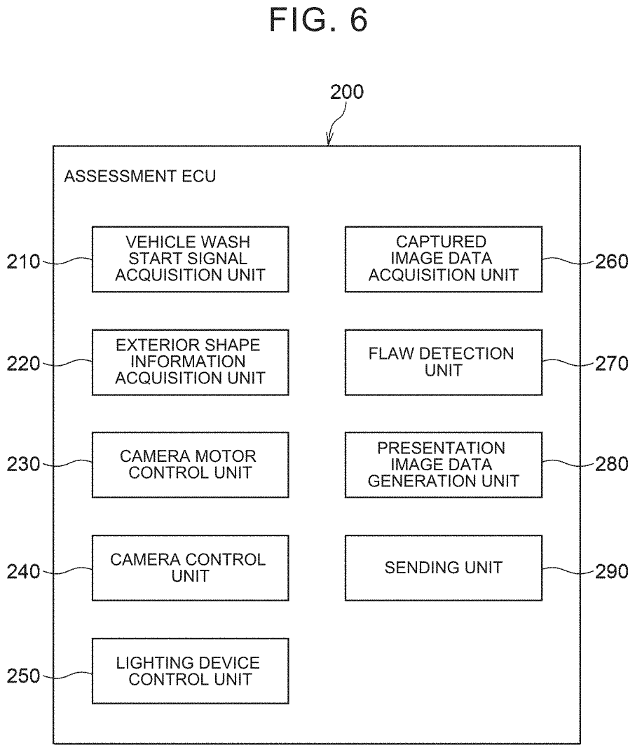

FIG. 6 is a block diagram showing an example of the functional components of the assessment ECU 200. The assessment ECU 200 includes a vehicle wash start signal acquisition unit 210, an exterior shape information acquisition unit 220, a camera motor control unit 230, a camera control unit 240, a lighting device control unit 250, a capture image data acquisition unit 260, a flaw detection unit 270, a presentation image data generation unit 280, and a sending unit 290. The functional components are implemented by the CPU 200A reading out the execution programs stored in the ROM 200B or the storage 200D and running the execution programs.

The camera motor control unit 230 may be regarded as a camera displacement control unit. The capture image data acquisition unit 260 may be regarded as an exterior image data acquisition unit.

The vehicle wash start signal acquisition unit 210 is a component that acquires a vehicle wash start signal output from the vehicle wash ECU 100. By acquiring a vehicle wash start signal, the assessment ECU 200 acquires a vehicle wash start timing.

The exterior shape information acquisition unit 220 is configured to acquire the exterior shape information of the vehicle V, which is a vehicle to be washed, from the vehicle wash ECU 100.

The camera motor control unit 230 is a component that, based on a vehicle exterior shape acquired from the exterior shape information acquisition unit 220, outputs drive signals to the camera motors 54 and moves the cameras 48 to locations according to the vehicle exterior shape information to ensure the viewing angles of the cameras 48 or to obtain appropriate location relations between the cameras 48 and the lighting devices 50.

The camera control unit 240 outputs an image capturing signal to each camera 48 placed at appropriate locations according to the exterior shape of the vehicle V such that the camera 48 sequentially captures an image at an appropriate timing in accordance with a change in relative location relation to the vehicle V.

The lighting device control unit 250 is a component that outputs a turn-on signal to the lighting device 50 associated with each camera 48 at an image capturing timing of the camera 48 and outputs a turn-off signal to the lighting device 50 at the end of image capturing.

The capture image data acquisition unit 260 is a component that acquires captured image data captured by each camera 48.

The flaw detection unit 270 is a component that detects flaws through image processing based on capture image data acquired by the capture image data acquisition unit 260. The flaw detection may be performed by known image processing.

The presentation image data generation unit 280 is a component that generates presentation image data to be presented to a user, in which flaw information is added by assigning a circle mark, an arrow mark, or the like to an area where a flaw is detected in the captured image data.

The sending unit 290 is a component that sends image data to be presented to a user, generated by the presentation image data generation unit 280, from the communication I/F 200E to a previously set user terminal 402 via the network 400.

### Operation

The operation of the vehicle exterior imaging system 10 configured as described above will be described.

Initially, a user who visits for a vehicle wash stops the vehicle V at a predetermined position in front of the vehicle washer 12. At this time, the user inputs a selected vehicle wash course, vehicle type (exterior shape information of a vehicle body), a destination to which presentation image data is sent (address or the like of the user terminal 402) to the vehicle wash information input device 34 disposed in front of the vehicle washer body 19.

The CPU 100A of the vehicle wash ECU 100 acquires vehicle wash course information, vehicle type information, user terminal address information, and the like from the vehicle wash information input device 34.

When an input completion signal is input from the vehicle wash information input device 34, the vehicle wash ECU 100 starts vehicle wash control in response to the input completion signal.

Subsequently, the CPU 100A of the vehicle wash ECU 100 extracts exterior shape information of the vehicle type from exterior shape information for each vehicle type, stored in the storage 100D, based on the vehicle type information input from the vehicle wash information input device 34. The CPU 100A of the vehicle wash ECU 100 outputs the exterior shape information to the assessment ECU 200.

Subsequently, the CPU 100A of the vehicle wash ECU 100 determines whether the vehicle V is stopped properly at the vehicle wash start position of the vehicle washer 12 based on an input signal from the position detection unit 36. When the CPU 100A determines that the vehicle V is properly stopped, the CPU 100A outputs a drive signal to the vehicle washer body drive motor 24, outputs a drive signal to the brush motor 110, and outputs a select signal to the electromagnetic selector valve 120. At this time, the vehicle wash ECU 100 outputs a vehicle wash start signal to the assessment ECU 200.

Thus, the vehicle washer body drive motor 24 is driven, and the vehicle washer 12 moves forward along the rails 22. The CPU 200A of the assessment ECU 200 also outputs a drive signal to the assessment device body drive motor 46, and the assessment device 14 moves forward together in synchronization with the vehicle washer 12 along the rails 22.

In the vehicle washer 12, the side brushes 26 and the top brush 28 are rotated by driving the brush motor 110, and air is blown from the side blower nozzles 30 and the upper blower nozzle 32 by opening the electromagnetic selector valve 120. Thus, the vehicle V is washed and dried.

The CPU 200A of the assessment ECU 200 receives (acquires) a vehicle wash start signal from the vehicle wash ECU 100 by using the vehicle wash start signal acquisition unit 210 and acquires the exterior shape information of the vehicle V from the vehicle wash ECU 100 by using the exterior shape information acquisition unit 220.

The CPU 100A of the assessment ECU 200 outputs a drive signal to each of the camera motors 54 (54A, 54C, 54E) by using the camera motor control unit 230 based on the exterior shape information to displace the cameras 48A, 48C, 48E along the respective rails 52A, 52C, 52E to optimal locations for flaw detection by sliding the cameras 48A, 48C, 48E.

For example, when the vehicle V is a sedan, the locations of the cameras 48A, 48C are displaced to lower locations. For example, when the vehicle V is a van, the locations of the cameras 48A, 48C are displaced to higher locations. When a roof is high and is close to the camera 48E as in the case of a van, it is conceivable to displace the camera 48E in the width direction (arrow W direction) to obtain a viewing angle.

Subsequently, at the timing at which the vehicle V is located inside the assessment device body 43 of the assessment device 14, the CPU 200A of the assessment ECU 200 sequentially outputs an image capturing signal to each of the cameras 48 by using the camera control unit 240 and outputs a turn-on signal to an associated one of the lighting devices 50 by using the lighting device control unit 250.

For example, initially, the image of the right side lower part of the vehicle V is captured by turning on the lighting device 50A and capturing the image with the camera 48B.

Subsequently, the image of the right side top part of the vehicle V is captured by capturing the image with the camera 48A in place of the camera 48B while the lighting device 50A is turned on.

Furthermore, the image of the top (top surface) of the vehicle V is captured by turning off the lighting device 50A, turning on the lighting device 50C or the lighting device 50D, and capturing the image with the camera 48E in place of the camera 48A.

Subsequently, the image of the left side top part of the vehicle V is captured by turning off the lighting device 50C or the lighting device 50D, turning on the lighting device 50B, and capturing the image with the camera 48C in place of the camera 48E.

Subsequently, the image of the left side lower part of the vehicle V is captured by capturing the image with the camera 48D in place of the camera 48C while the lighting device 50B is turned on.

In this way, when the image of the exterior of the vehicle V is captured by each of the cameras 48A, 48B, 48C, 48D, 48E, the image is captured while only the associated one of the lighting devices 50 is turned on, so halation or the like is suppressed. Since the image is captured inside the assessment device body 43, incidence of ambient light to the cameras 48 is prevented or reduced.

The entire image of the vehicle V is captured by repeatedly capturing images with the cameras 48A, 48B, 48C, 48D, 48E at different locations in the front and rear direction of the vehicle V.

Image capturing with the camera 48F and turning on the lighting device 50E are performed after the vehicle washer body 19 and the assessment device body 43 pass over the vehicle V and when the vehicle V passes over the camera 48F and the lighting device 50E, and captured image data of the bottom surface of the vehicle V is acquired.

In this way, the CPU 200A of the assessment ECU 200 acquires captured image data obtained by capturing the image of the vehicle V with the cameras 48A, 48B, 48C, 48D, 48E, 48F by using the capture image data acquisition unit 260.

Subsequently, the CPU 200A of the assessment ECU 200 detects flaw areas in each image by applying image processing to the pieces of captured image data by using the flaw detection unit 270.

The CPU 200A of the assessment ECU 200 generates presentation image data in which the detected flaw information is added, by using the presentation image data generation unit 280. For example, the CPU 200A generates presentation image data subjected to image processing, such as a circle mark and an arrow mark, is assigned to a flaw on a captured image.

The CPU 200A of the assessment ECU 200 sends the presentation image data to the user terminal 402 from the communication I/F 200E via the network 400 by using the sending unit 290.

After the end of washing of the vehicle V, a user or a manager is able to check for flaws on the vehicle V and the locations and the like of the flaws only by viewing the presentation image data sent to the user terminal 402.

In this way, with the vehicle exterior imaging system 10 according to the present embodiment, at the time of washing the vehicle V, the user or the manager is able to easily check for flaws on the vehicle V, the locations of the flaws, the shapes of the flaws, and the like.

Particularly, since the assessment device 14 includes the cameras 48A, 48B, 48C, 48D, 48E on the inner side of the assessment device body 43, incidence of ambient light reflected from the exterior of the vehicle V to the cameras 48A, 48B, 48C, 48D, 48E is prevented or reduced, so images that allow easy detection of flaws are able to be captured with the cameras 48A, 48B, 48C, 48D, 48E.

When the image is captured by the camera 48F, the camera 48F is not covered with the assessment device body 43; however, the camera 48F is covered with the vehicle V, so an image that allows easy detection of flaws is able to be similarly captured by the camera 48F.

Since the image is sequentially captured by each of the cameras 48A, 48B, 48C, 48D, 48E, 48F and only one of the lighting devices 50A, 50B, 50C, 50D, 50E respectively associated with the cameras 48A, 48B, 48C, 48D, 48E, 48F is turned on at the time of image capturing, halation or the like due to turning on of another lighting device on a captured image is prevented or reduced, so flaws are accurately detected from the captured image.

Since the cameras 48A, 48C, 48E are configured to be displaceable to locations where an appropriate image is able to be captured, in accordance with the exterior shape of the vehicle V, an image appropriate for flaw detection is captured even when the exterior shape of the vehicle V changes. For example, it is possible to ensure the viewing angle of each of the cameras 48A, 48C, 48E and appropriately adjust the incident angle of reflected light from the lighting devices.

The exterior shape information of the vehicle V is at least partially needed for the vehicle washer 12 as well, so the exterior shape information of the vehicle V may be shared between the vehicle washer 12 and the assessment device 14.

### Variation 1

In the vehicle exterior imaging system 10 according to the above embodiment, after the vehicle V is washed (dried) by the vehicle washer 12, the image of the vehicle V is captured by the cameras 48 of the assessment device 14. Alternatively, it is conceivable that the image of the vehicle V is captured by the cameras 48 of the assessment device 14 before a vehicle wash as well.

When captured image data before and after a vehicle wash is sent to the user terminal 402, the user or the manager is able to visually recognize the degree of soil removal of the vehicle V.

Alternatively, it is conceivable that the CPU 200A of the assessment ECU 200 generates a differential image obtained by taking a difference between captured images before assessment and captured images after assessment and sending the differential images to the user terminal 402.

In this case, such an advantageous effect that the user or the manager is easy to check the cleaning effect with the vehicle washer 12 is obtained.

### Variation 2

In the vehicle exterior imaging system 10 according to the above embodiment, presence or absence of flaws, the locations of the flaws, and the like are just provided to the user or the manager by using presentation images. Alternatively, a certificate (image capturing information) describing a date of image capturing, a place of image capturing, the license number of a subject vehicle, and the like may be attached to presentation image data, and the image capturing information may be provided as objective flaw information on the vehicle.

For example, when the user shows the presentation image data together with the certificate, the user is able to use the presentation image data for used vehicle assessment or the like on the Internet.

### Others

In the vehicle exterior imaging system 10 of the present embodiment, only the cameras 48A, 48C, 48E that are some of the cameras 48 are configured to be movable. Alternatively, another one or some of the cameras 48 may also be configured to be movable or all the cameras 48 may be configured to be movable.

In the vehicle exterior imaging system 10 of the present embodiment, the lighting devices 50 are fixed to the inner side of the assessment device body 43. Alternatively, the lighting devices 50 may also be configured to be displaceable similarly to the camera 48A and the like. By displacing the lighting devices 50 in accordance with the exterior shape of the vehicle V, it is possible to adjust the incident angle of reflected light from the lighting devices 50 to the cameras 48, so it is conceivable that the accuracy of flaw detection based on captured images further improves.

In the vehicle exterior imaging system 10 of the present embodiment, exterior shape information, such as a vehicle type, is acquired from the vehicle wash information input device 34 to which the user inputs the exterior shape information. Alternatively, a vehicle body exterior shape may be detected by sensors provided in the vehicle washer body 19.

In the vehicle exterior imaging system 10 of the present embodiment, the vehicle washer body 19 and the assessment device body 43 are configured to move in a state where a vehicle is stopped. Alternatively, a vehicle may be configured to move in a state where the vehicle washer body 19 and the assessment device body 43 are fixed.

The embodiment is described above; however, the disclosure may be, of course, implemented in various modes without departing from the scope of the disclosure.

What is claimed is:

1. A vehicle exterior imaging system comprising:
an exterior image data acquisition unit configured to acquire exterior image data of a washed vehicle of which an image is captured by an imaging apparatus integrally provided with a vehicle washer that washes the vehicle while moving relative to the vehicle;
a flaw detection unit configured to detect flaws on an exterior of the vehicle based on the exterior image data; and
a presentation image data generation unit configured to generate presentation image data in which flaw information detected by the flaw detection unit is added to the exterior image data.

2. The vehicle exterior imaging system according to claim 1, further comprising a sending unit configured to send the presentation image data to a terminal of a user of the vehicle or a terminal of a manager of the vehicle.

3. The vehicle exterior imaging system according to claim 1, wherein the exterior image data acquisition unit is configured to acquire exterior image data of the vehicle with the imaging apparatus even before a vehicle wash of the vehicle.

4. The vehicle exterior imaging system according to claim 1, wherein:
the imaging apparatus includes a housing covering an area through which the vehicle relatively passes; and
the imaging apparatus includes a camera placed on an inner side of the housing and configured to capture an image of the exterior of the vehicle.

5. The vehicle exterior imaging system according to claim 4, wherein the imaging apparatus includes a plurality of cameras configured to respectively capture images of different areas of the exterior of the vehicle in a cross section perpendicular to a direction in which the vehicle moves relative to the imaging apparatus.

6. The vehicle exterior imaging system according to claim 5, wherein:
the imaging apparatus includes a plurality of lighting devices respectively associated with the plurality of cameras; and
each of the plurality of cameras is configured to sequentially capture an image of the exterior of the vehicle in a state where only the lighting device associated with an associated one of the cameras is turned on.

7. The vehicle exterior imaging system according to claim 5, wherein the imaging apparatus includes
an exterior shape information acquisition unit configured to acquire exterior shape information of a vehicle; and
a camera displacement control unit configured to displace the camera to a location according to the exterior shape of the vehicle based on the exterior shape information.

8. The vehicle exterior imaging system according to claim 1, wherein the presentation image data generation unit is configured to generate presentation image data in which capture date and time information and capture place information are added to exterior image data of the washed vehicle.
